(19) United States
(12) Patent Application Publication
(10) Pub. No.: US 2026/0286072 A1
(43) Pub. Date: Sep. 24, 2026

(54) Reinforced Thermoplastic Composite from Airborne Yarn Waste and Cotton Waste Dust.

(71) Applicants: Michael Bernstein, Atlanta, GA (US); Asif Malik, Lahore (PK); Ali Imran, Lahore (PK)

(72) Inventors: Michael Bernstein, Atlanta, GA (US); Asif Malik, Lahore (PK); Ali Imran, Lahore (PK)

(21) Appl. No.: 19/086,676

(22) Filed: Mar. 21, 2025

(51) Int. Cl. C08J 5/04; B29B 9/06; B29B 13/06; B29K 23/00; B29K 311/10; B33Y 70/10; C08L 23/06; C09D 7/40; C09D 7/65; C09D 123/06

(52) U.S. Cl. CPC C08J 5/045; B29B 9/065; B29B 13/065; B33Y 70/10; C08J 5/046; C08L 23/06; C09D 7/65; C09D 7/70; C09D 123/06; B29K 2023/065; B29K 2311/10; C08J 2323/06; C08L 2203/30; C08L 2205/16; C08L 2207/062; C08L 2207/20

(57) ABSTRACT

The present invention relates to a blended composition and method for forming the blended composition. The blended composition is configured for injection molding into a product. The composition comprises airborne yarn waste and/or cotton waste dust (waste/dust) in a plug form, a bonding agent, and a thermoplastic polymer. The composition creates a reinforced composite material through the compounding of the waste/dust with the thermoplastic polymer and bonding agent. The method for forming the blended composition involves several steps: collecting the waste/dust, introducing the waste/dust into a vented twin-screw extruder, blending with the thermoplastic polymer and bonding agent, and heating the thermoplastic polymer to a temperature that sufficiently softens or melts the polymer.

### FIELD OF THE INVENTION

The present invention relates to the use of airborne yarn waste and cotton waste dust to reinforce thermoplastic composites, and more particularly, the present invention relates to a system, an apparatus and a method of manufacturing a cotton waste plug from airborne yarn waste and cotton waste dust for blending with a thermoplastic polymer for the manufacturing of a novel reinforced composite.

### BACKGROUND

### Interpretation Considerations

This section describes the technical field in detail and discusses problems encountered in the technical field. Therefore, statements in the section are not to be construed as prior art.

### Discussion

The rise of fast fashion has significantly increased the production and disposal of clothing, leading to a surge in textile waste and global pollution. Globally, the fashion industry is responsible for approximately 10% of carbon emissions, 20% of industrial water pollution, and extensive land and resources used for fiber production. Despite advancements in recycling technologies, less than 1% of clothing is recycled into new textiles, with most apparel waste ending up in landfills or being incinerated, exacerbating environmental harm. Though textile recycling methods have evolved, the effective reuse and recycling of both pre-consumer (manufacturing scraps) and post-consumer (discarded clothing) apparel waste still remain unresolved. Cotton-based materials, which are widely used in the production of textiles, generate substantial amounts of apparel waste during various processing stages. This waste is often discarded or underutilized, leading to resource inefficiencies and environmental harm.

Recycling waste apparel from textile fabrication presents significant challenges due to the low-density and amorphous nature of cotton waste or airborne yarn waste. These characteristics make transportation inefficient, as the material is bulky, lightweight, and prone to entanglement, requiring extensive handling and large storage volumes. The same issues also create challenges when feeding into compounding processes for reinforced composites. Its irregular structure prevents smooth and consistent feeding, leading to poor dispersion within the composite matrix. Unlike granular or pelletized reinforcements, cotton waste resists uniform mixing, resulting in material inconsistencies that compromise the biomechanical properties of the final composite. These processing difficulties limit the scalability and practicality of using cotton waste in advanced material applications.

The patent WO2021250228A1 focuses on utilizing recycled post-consumer waste to produce reinforced composite materials, specifically emphasizing the collection and processing of fibrous waste from discarded textiles and plastics rather than pre-consumer yarn waste or other pre-consumer waste. The process involves harvesting post-consumer waste through municipal or industrial collection, sorting to remove contaminants, and converting it into a usable form for compounding with resins or binders. However, post-consumer waste presents several manufacturing and operational inefficiencies. Feeding post-consumer cotton into compounding machines also poses challenges due to its physical form, as loose, lightweight fibers do not disperse uniformly within the polymer matrix, leading to inconsistent fiber distribution and reduced composite performance. Additionally, post-consumer fibers often retain dyes, chemical treatments, and contaminants from prior use, which can negatively affect the final composite properties. Removing or neutralizing these chemicals requires additional processing steps such as washing, bleaching, or chemical treatments, increasing complexity and cost.

Beyond the transportation challenges, achieving uniform dispersion of reinforcement materials within a polymer matrix is critical to ensuring optimal mechanical properties. However, when cotton or other recycled textiles are used, they exhibit poor dispersion rates when blended with thermoplastic polymers such as high-density polyethylene (HDPE). The fibrous structure results in uneven distribution within the molten polymer, leading to inconsistencies in the final composite material. This poor integration can result in weak points, reducing the overall strength and durability of the composite.

Existing solutions for recycling cotton fiber focus on low-value applications, such as insulation or padding materials. These methods fail to leverage the potential of pre-consumer apparel waste for creating durable materials with enhanced properties, such as improved tensile strength or rigidity. Furthermore, there is a lack of cost-effective and scalable technologies capable of transforming this underutilized resource into valuable products.

Therefore, there is a pressing need for an apparatus and method that simplifies the collection and processing of pre-consumer cotton waste dust or airborne yarn waste into a form factor conducive to transportation and feeding into an extruder for yielding reinforced composites.

### SUMMARY

An objective of the present invention is to provide an apparatus and method for compacting airborne yarn waste and, or cotton waste dust into a cotton waste plug. By incorporating a cotton waste plug into the composite, the material exhibits higher tensile strength, making it suitable for a wide range of applications where durability is crucial.

Another advantage of the present invention is the formation of a compact cotton waste plug by converting the airborne yarn waste and, or cotton waste dust into a plug form. This transformation makes the transportation of cotton waste much more efficient and cost-effective. By minimizing the volume of the waste, it becomes easier to handle and transport from one location to another, thereby reducing logistical costs and environmental impact.

Cotton waste dust and airborne yarn waste (dust/waste) are two distinct types of pre-consumer cotton waste materials that serve as inputs for the compaction process to create cotton waste plugs. Cotton waste dust is a fine particulate byproduct generated during the combing process, where short fibers, broken fragments, and impurities are separated from longer staple fibers to enhance yarn quality. This dust, collected through extraction and filtration systems, is reintroduced into the spinning process to create yarn, maximizing fiber utilization. In contrast, airborne yarn waste consists of larger fiber clusters, stray filaments, and lint that become detached and suspended in the air during fabrication processes such as spinning, weaving, and knitting. This waste, which is captured through air filtration systems, represents an additional input for cotton waste plug production. Both cotton waste dust and airborne yarn waste are inputs for the compaction process, where they are compressed into cotton waste plugs for downstream reinforced composite manufacturing. Optionally, the cotton waste plug may be compacted from either input alone.

Furthermore, the present invention offers reduced production costs. By leveraging waste materials and optimizing manufacturing processes, the cost of producing these composites is significantly lower than traditional methods, making them more accessible to industries seeking sustainable solutions.

Additionally, the present invention boosts the reusability and value of airborne yarn waste and, or cotton waste dust. By transforming this underutilized resource into durable end products, the invention contributes to resource efficiency and waste reduction, aligning with sustainable development goals.

This and other objectives are achieved by providing a system, an apparatus and a method for manufacturing a cotton waste plug and a blended composition with the features in the independent claims.

According to the first aspect of the present invention, the present invention provides a cotton waste plug from airborne yarn waste and, or cotton waste dust. The cotton waste plug comprises airborne yarn waste and, or cotton waste dust collected by vacuuming through a negative air environment. Further, the waste/dust is compacted into a cotton waste plug shape configured for at least one of ease of transport and storage.

In another embodiment of the present invention, the cotton waste plug is processed into a plug shape by vacuuming waste/dust from the air through a negative air environment and compacting the waste/dust into a cylindrical shape. The waste/dust is compacted into the plug shape using at least one of mechanical pressing, hydraulic compression, extrusion-based densification, thermal bonding, or chemical binding agents.

In one embodiment of the present invention, the formation of the cotton waste plug is not a result of deliberate compaction, post-processing, or secondary shaping steps. Instead, the plug assumes its final form as a natural consequence of the manufacturing process. Specifically, the system utilizes a negative air pressure environment to collect dust/waste, directing it through a controlled airflow system into a compaction chamber where it is consolidated into a cylindrical shape. As the continuous column of compacted waste/dust exits the processing apparatus through tubing or piping, gravitational forces cause the material to segment naturally into discrete, uniformly shaped plugs. The inherent structural integrity of the compacted cotton fibers, combined with the controlled exit conditions, ensures that the plugs break off with consistent dimensions, texture, and mechanical properties, eliminating the need for additional processing steps to achieve the final shape.

In yet another embodiment of the present invention, the cotton waste plug further comprises a humidity level of less than 10%.

According to a second aspect of the invention, the invention provides an apparatus for manufacturing a cotton waste plug. The apparatus comprises an input source unit, a plunger unit and an output unit. The input source unit receives and vacuums the waste/dust from the air through a negative air environment. The plunger unit compacts the received waste/dust. The output unit compacts and outputs the waste/dust into a plug shape.

In an embodiment of the present invention, the plunger unit compacts the waste/dust into the plug shape using at least one of mechanical pressing, hydraulic compression, extrusion-based densification, thermal bonding, or chemical binding agents.

In an embodiment of the present invention, the output unit includes a shaping die structure to output the compacted plug in any desired shape and dimension.

According to a third aspect of the present invention, the invention provides a method of manufacturing a cotton waste plug. The method comprises the steps of a) obtaining airborne yarn waste/cotton waste dust from pre-consumer industrial sources; and b) compacting the dust/waste into a plug shape using at least one of mechanical pressing, hydraulic compression, extrusion-based densification, thermal bonding, or chemical binding agents.

In yet another aspect of the present invention, the plug shape is further combined with a thermoplastic polymer and bonding agent to produce a reinforced composite material.

In yet another aspect of the present invention, the airborne yarn waste and cotton waste dust may be collected and combined with the thermoplastic polymer and bonding agent to produce the reinforced composite material, without the need to form the yarn waste/cotton waste dust into a plug shape or cotton waste plug.

In one embodiment of the present invention, the reinforced composite material is outputted as pellets from the compounding process, ensuring uniform dispersion of the cotton waste fibers within the thermoplastic polymer matrix. The incorporation of the cotton waste plug-derived fibers into the polymer results in enhanced bio-mechanical properties, including improved tensile strength, impact resistance, and flexural modulus. The natural fiber reinforcement contributes to increased durability and load-bearing capacity, making the composite material suitable for demanding structural applications. Additionally, the inherent characteristics of cotton fibers, such as their low density and ability to enhance thermal and acoustic insulation, further expand the material's potential applications.

Once formed into pellets, the reinforced composite material can be subsequently injection molded into a wide range of end-use consumer and industrial products. Potential applications include durable pallets for logistics and shipping, eco-friendly furniture components, hangers, automotive interior panels, construction materials such as decking boards and wall panels, and consumer goods like storage bins, tool handles, and packaging materials. The ability to efficiently integrate airborne yarn waste and, or cotton waste dust into thermoplastic composites not only improves the sustainability of these end-products but also contributes to circular economic efforts by repurposing textile waste into high-performance materials.

Further objectives, features, and advantages of the present invention will become apparent when studying the following detailed disclosure, the drawings, and the appended claims. Those skilled in the art will realize that different features of the present invention can be combined to create embodiments other than those described in the following.

### BRIEF DESCRIPTION OF THE DRAWINGS

The drawings illustrate the design and utility of embodiments of the present invention, in which similar elements are referred to by common reference numerals. In order to better appreciate the advantages and objects of the embodiments of the present invention, reference should be made to the accompanying drawings that illustrate these embodiments. However, the drawings depict only some embodiments of the invention and should not be taken as limiting its scope. With this caveat, embodiments of the invention will be described and explained with additional specificity and detail through the use of the accompanying drawings in which:

FIG. 1 illustrates a system for forming a reinforced composite material in accordance with an embodiment of the present invention;

FIG. 2 illustrates an apparatus for manufacturing a cotton waste plug in accordance with an embodiment of the present invention;

FIG. 3 illustrates sub-modules of a system for forming a reinforced composite material in accordance with an embodiment of the present invention;

FIG. 4 illustrates an injection molding module of a system in accordance with an embodiment of the present invention;

FIG. 5 illustrates test results of the final reinforced composite after pelletizing and before injection molding in accordance with an embodiment of the present invention;

FIG. 6 illustrates test results of the final reinforced composite after pelletizing and before injection molding in accordance with an embodiment of the present invention;

FIG. 7 illustrates a method flow diagram for manufacturing a cotton waste plug in accordance with an embodiment of the present invention;

FIG. 8 illustrates a method flow diagram for forming a blended composition in accordance with an embodiment of the present invention; and

FIG. 9 illustrates a method flow diagram for injection molding a blended composition to form an end product in accordance with an embodiment of the present invention.

The illustrated embodiments are merely examples and are not intended to limit the disclosure. The schematics are drawn to illustrate features and concepts and are not necessarily drawn to scale.

### DETAILED DESCRIPTION

The present disclosure is best understood with reference to the detailed figures and description set forth herein. Various embodiments have been discussed with reference to the figures. However, a person skilled in the art will readily appreciate that the detailed descriptions provided herein with respect to the figures are merely for explanatory purposes, as the methods and system may extend beyond the described embodiments. For instance, the teachings presented, and the needs of a particular application may yield multiple alternatives and suitable approaches to implement the functionality of any detail described herein. Therefore, any approach may extend beyond certain implementation choices in the following embodiments.

Methods of the present invention may be implemented by performing or completing, executing manually, automatically, or a combination thereof, selected steps or tasks. The term “method” refers to manners, means, techniques, and procedures for accomplishing a given task, including, but not limited to, those manners, means, techniques, and procedures either known to or readily developed from known manners, means, techniques, and procedures by practitioners of the art to which the invention belongs. The descriptions, examples, methods, and materials presented in the claims and the specification are not to be construed as limiting but rather as illustrative only. Those skilled in the art will envision many other possible variations within the scope of the technology described herein.

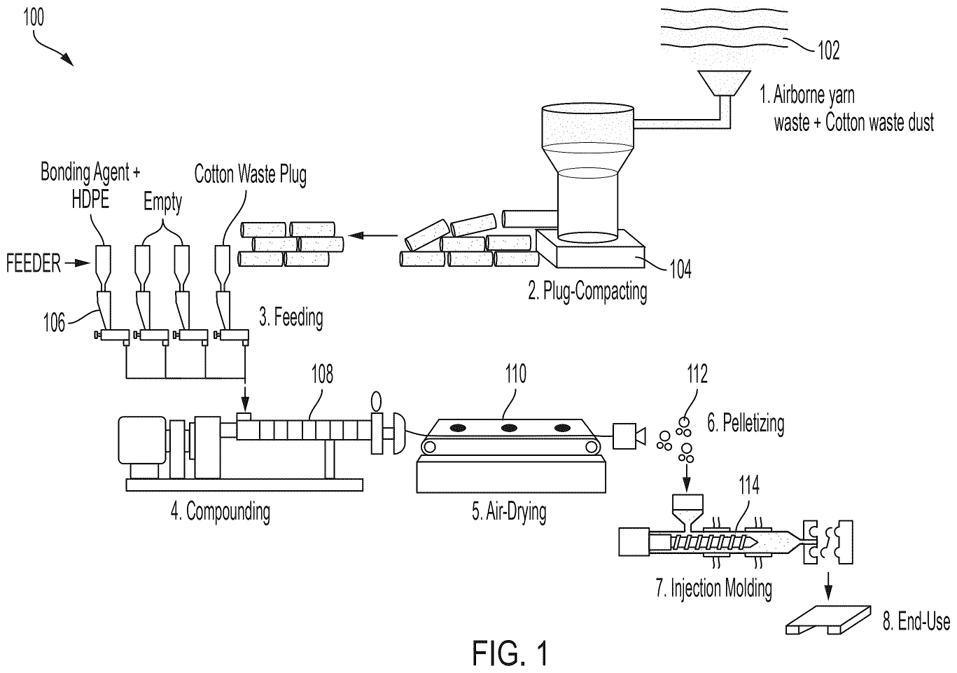

FIG. 1 illustrates a system 100 for forming a reinforced composite material in accordance with an embodiment of the present invention. The system 100 comprises a collection module 102, an apparatus 104, a feeding module 106, a compounding module 108, a drying module 110, a pelletizing module 112, and an injection molding module 114.

The collection module 102 collects an airborne yarn waste or cotton waste dust (waste/dust) from various sources, including fabrication and recycling processes. The cotton waste dust and the airborne yarn waste are pre-consumer cotton waste materials used in creating cotton waste plugs. The cotton waste dust, a fine byproduct from combing, is collected via filtration and reused in yarn production, while the airborne yarn waste, consisting of larger fiber clusters and lint from the knitting/weaving process, is captured through air filtration or cleaning. Both are vital for recycling and sustainable textile production, with distinct compositions and collection methods.

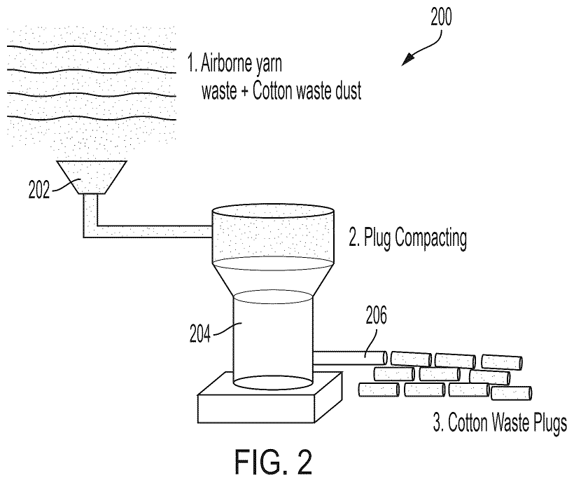

The apparatus 104 receives the airborne yarn waste or the cotton waste dust from the collection module 102. The apparatus 104 is configured to compact or compress the received airborne yarn waste or the cotton waste dust to a cotton waste plug. The functionality and structure of the apparatus 104 is discussed in detail in FIG. 2. The apparatus 104 addresses a critical need in the textile industry by providing a method to recycle waste materials.

The feeding module 106 receives the compacted or compressed cotton waste plug from the apparatus 104. The feeding module 106 may include one or more feeding units, configured to receive a thermoplastic polymer and a bonding agent.

The compounding module 108 receives the compacted or compressed cotton waste plug, the thermoplastic polymer and the bonding agent from the feeding module 106 to form a reinforced composite material or a blended composition. The compounding module 108 may include an extruder to form a strand-like structure of the blended composition which is further fed to the drying module 110.

The drying module 110 receives the strand-like structure or string of the blended composition directly from the compounding module 108 and performs a thorough drying operation. The drying module 110 ensures the removal of excess moisture from the material, which is essential for maintaining the quality, stability, and performance of the composition in subsequent manufacturing stages.

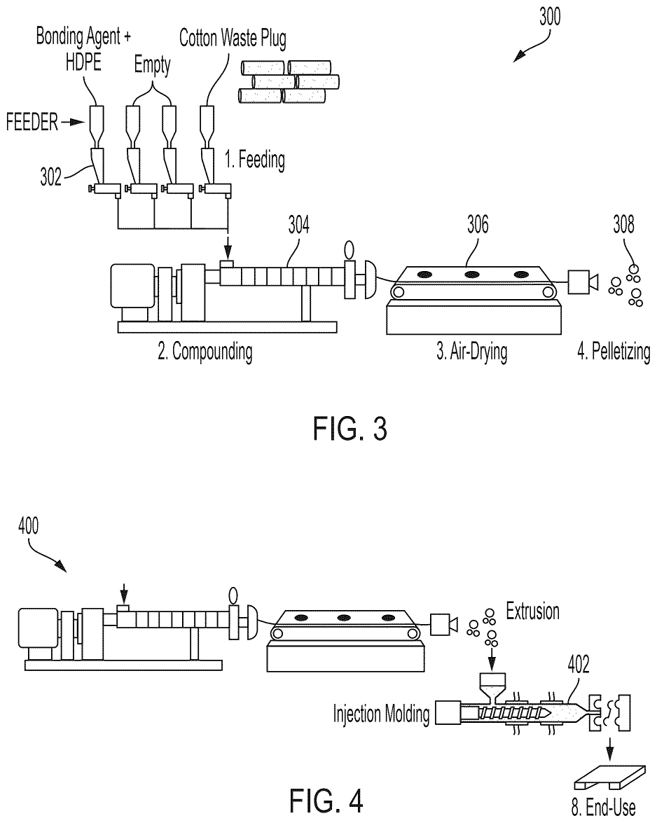

The pelletizing module 112 receives the dried strands or strings of the blended composition from the drying module 110 and cuts the dried strands or strings into pellets. The feeding module 106, the compounding module 108, the drying module 110 and the pelletizing module 112 are discussed in detail in FIG. 3.

The injection molding module 114 is injection molded into an end or a finished product. The end or finished product is a structural product used for transport and storage applications. The injection molding module 114 is discussed in detail in FIG. 4. The system 100 is designed to efficiently manufacture high-performance, durable composites suitable for various industrial applications.

FIG. 2 illustrates an apparatus 200 for manufacturing a cotton waste plug in accordance with an embodiment of the present invention. The apparatus 200 comprises an input source unit 202, a plunger unit 204, and an output unit 206.

The input source unit 202 is designed with a funnel shape, allowing it to efficiently receive airborne yarn waste or cotton waste dust from various sources, including fabrication and recycling processes or from the collection module (discussed in FIG. 1). This design ensures that the airborne yarn waste or the cotton waste dust is collected effectively, minimizing waste and maximizing the input material for processing.

The input source unit 202 may include a cabinet (not shown) to collect the airborne yarn waste or the cotton waste dust, which serves as a central processing chamber. The input source unit 202 or the cabinet is equipped with a vacuum pump that creates a negative pressure environment or suction force. This suction force is crucial for attracting and retaining the airborne yarn waste within the apparatus 200, ensuring that the material is properly contained and prepared for further processing.

The input source unit 202 may comprise a de-lumper unit (lump breaker) to break the airborne yarn waste or the cotton waste dust into smaller, uniform pieces to facilitate consistent feeding. The de-lumper unit may be connected at the input or the output end of the input source unit 202.

Once the cabinet is full, the airborne yarn waste or the cotton waste dust is directed to the plunger unit 204. The plunger unit 204 is responsible for compacting or compressing the airborne yarn waste at 100 PSI into a densified or compressed cotton waste plug. The plunger unit 204 may utilize at least one mechanical pressing, hydraulic compression, extrusion-based densification, thermal bonding, or chemical binding agents to apply the necessary pressure for compacting or compressing the airborne yarn waste or the cotton waste dust into a compressed cotton waste plug. The plunger unit 204 may be a linear plunger. Alternatively, the plunger unit 204 is a rotary plunger. The plunger unit 204 comprises at least one screw type, hydraulic type, piston type, and/or roller type. This process is essential for converting the loose airborne yarn waste into a more manageable and usable product.

The cotton waste plug comprises at least one of wool, flax, hemp, jute, polyester, nylon, or other natural or synthetic textile fibers obtained from pre-consumer apparel waste.

In one example, a humidity level of the cotton waste plug is less than 10%.

The output unit 206 is configured to output the densified cotton waste plug from the apparatus 200. The output unit 206 is equipped with a shaping die responsible for the shape of the densified cotton waste plug.

Further, the length of the shaping die decides the length of the cotton waste plug leaving the output unit 206. The length of the shaping die may cause a breaking line over the output at a certain length due to gravity applying over the output.

In one example, the shape of the densified cotton waste plug is cylindrical.

In another example, the shape of the densified cotton waste plug is square or rectangular.

The densified cotton waste plug may form into various shapes depending on the shape of the shaping die.

As the densified cotton waste plug exits the output unit 206, gravity breaks the densified cotton waste plug apart at a level where the gravity overcomes the weight to create the plug. The plug could be made shorter by increasing the height of the cabinet or lowering the exit tube.

The densified cotton waste plug offers improved transportability and storability compared to conventional fragile cotton sheets due to its enhanced density.

Alternatively, the output unit 206 may comprise a cutting unit or a mechanical cutter for breaking the output or the compacted blended composition.

The term “cotton waste plug”, “the plug” or “densified cotton waste plug” is used interchangeably throughout the specification and refer to the same entity and meaning. It conventionally refers to the processed product of airborne yarn waste but may refer to an unprocessed version of the collected airborne yarn waste.

FIG. 3 illustrates sub-modules of a system 300 for forming a reinforced composite material in accordance with an embodiment of the present invention. The system 300 includes a feeding module 302, a compounding module 304, a drying module 306, and a pelletizing module 308.

The feeding module 302 receives the compacted or compressed cotton waste plug from the apparatus (discussed in detail in FIG. 2). The feeding module 302 may include one or more feeding units, configured to receive a thermoplastic polymer, a bonding agent and the cotton waste plug. The feeding module 302 is designed to facilitate the integration of various materials necessary for creating a blended composition or the reinforced composite material.

For example, the first feeding unit 302-1 is configured to receive a thermoplastic polymer, which serves as the matrix material in the blended composition. The second feeding unit 302-2 is designated for the bonding agent, which enhances the adhesion between the polymer and the cotton waste plug. Additionally, the third feeding unit 302-3 is intended for delayed feeding and is currently shown as empty, indicating that the third feeding unit 302-3 may be used for future material inputs or adjustments in the process. The fourth feeding unit 302-4 is specifically tasked with receiving the cotton waste plug either directly or from the apparatus (discussed in FIG. 2), ensuring that this key component is efficiently integrated into the blended composition formulation. In one scenario, the fourth feeding unit 302-4 may receive the cotton waste plug from the apparatus either through a direct connection or via a conveyor belt, facilitating efficient material transfer into the composite formation process. The cotton waste plugs are introduced at a controlled rate via the fourth feeding unit 302-4. This structured approach within the feeding module 302 optimizes material handling and preparation, ultimately contributing to the production of high-quality reinforced composites.

In one example, the fourth feeding unit 302-4 may include a de-lumper unit or lump breaker to break the cotton waste plugs into small uniform pieces. The small uniform pieces of cotton waste facilitate consistent feeding.

In another example, the first and second feeding units (302-1, 302-2) may also include a de-lumper unit or lump breaker to break the thermoplastic polymer and the bonding agent into small uniform pieces.

The de-lumper is connected at an input end of the feeding units (302-1, 302-2, 302-4). In an alternate embodiment of the present invention, the de-lumper is connected at an output end of the feeding units (302-1, 302-2, 302-4).

The feeding module 302 may include a chamber module (not shown). The chamber module further comprises one or more chamber units for storing the thermoplastic polymer, the bonding agent and the cotton waste plug.

The compounding module 304 receives the compacted or compressed cotton waste plug, the thermoplastic polymer and the bonding agent from the feeding module 302 to form a reinforced composite material or a blended composition. The compounding module 304 includes a heating unit (not shown). The heating unit may comprise a feed zone, melting zone, and/or melt-pumping zone. The feed zone receives the small uniform pieces of the cotton waste plug or the airborne yarn waste, the thermoplastic polymer, and the bonding agent. The melting zone may include a heater for heating the thermoplastic polymer to a temperature sufficient to soften or melt the polymer.

The melt-pumping zone of the heating unit is utilized for pumping or forcing the cotton waste plug or the airborne yarn waste, the bonding agent and the thermoplastic polymer in a forward direction or towards the drying module 306. The heating unit facilitates the controlled blending of the melted thermoplastic polymer, the bonding agent with the cotton waste plug or the airborne yarn waste to form a blended composition or a reinforced composite material. The heating unit facilitates the uniform dispersion of the small uniform cotton waste plug or the airborne yarn waste within the thermoplastic polymer matrix. The heating unit may utilize a screw-type compactor which is of a low-shear screw design to prevent degradation or burning of the fibers during the blending process.

Alternatively, the airborne yarn waste or cotton waste plug is blended with the thermoplastic polymer and the bonding agent in a melt compounding process utilizing at least one of a twin-screw extruder, continuous mixer, or batch mixer to ensure controlled blending. In one example, the cotton waste dust is directly fed into the polymer melt, while in other cases, the cotton waste plug itself is introduced into the melt and broken down during processing.

The heating unit may comprise a heater and/or a temperature sensor. The temperature sensor monitors real-time temperature to aid the heater or the heating unit in maintaining the sufficient temperature required for the melting of the thermoplastic polymer. The heating unit may perform extrusion of the blended composition and force the blended composition towards an output unit of the compounding module 304.

The output unit outputs a strand-like structure or string of the blended composition. The compounding module 304 may include an extruder to form a strand-like structure or a string of the blended composition which is further fed to the drying module 306.

The drying module 306 receives the strand-like structure or the string of the blended composition. The strands-like structure or string of the extruded blended composition is introduced into a water bath or A.C.-enclosed conveyor belt to solidify (cool and dry without the water bath) while retaining residual heat to evaporate surface moisture. The drying module 306 ensures the removal of excess moisture from the material, which is essential for maintaining the quality, stability, and performance of the composition in subsequent manufacturing stages. The extruded blended composition is in continuous form or pelletized using a shaping die. The cooled string may be further pelletized for feeding into injection molding applications or may be spooled to form a roll for feeding into a 3-D printer for B2C applications.

The pelletizing module 308 is a vital component of the composite material production system, responsible for transforming dried strands or strings of blended composition received from the drying module 306. Once the blended composition has undergone drying to remove moisture, the composition is presented in the form of elongated strands. The pelletizing module 308 then employs an extrusion process to cut these dried strands into uniform pellets. This process not only standardizes the size and shape of the pellets but also ensures that they are suitable for subsequent processing stages, particularly injection molding, as elaborated in FIG. 4. The extrusion technique used in the pelletizing module allows for efficient handling and processing of the material, facilitating its conversion into a form that can be easily transported and utilized in manufacturing. By producing consistent pellets, pelletizing module 308 enhances the overall efficiency and quality of the composite material production process, ensuring that the final products exhibit desirable properties and performance characteristics. This step is crucial in preparing the blended composition for effective integration into various applications across multiple industries.

In one of the embodiments, the cotton waste plug or collected airborne yarn waste may be introduced through a side feeder into chamber 4 or so of the 10-chamber twin-screw heating process, allowing the thermoplastic polymer and bonding agent mixture to fully homogenize before encountering the fibers. By positioning the plug input point downstream from the thermoplastic polymer and bonding agent feeders, the system 300 ensures that the polymer blend has sufficient time to melt and mix thoroughly before interacting with the yarn or cotton waste, promoting uniform dispersion and enhancing fiber-matrix adhesion in the final reinforced composite material. Other feeding chambers are possible in order to allow the thermoplastic polymer and bonding agent mixture to fully homogenize before encountering the fibers.

FIG. 4 illustrates an injection molding module 402 of a system 400 in accordance with an embodiment of the present invention. The injection molding module 402 is designed to receive pellets produced by the pelletizing module, which is discussed in detail in FIG. 3. Once the pellets are delivered to the injection molding module 402, they undergo a transformation process where they are heated and injected into molds to create finished products or end products. The injection molding process allows for precise control over the shape and characteristics of the finished product, ensuring that it meets specific design and performance criteria. The injection molding module 402 not only enhances the efficiency of production but also enables the creation of complex geometries and structures that are essential in various applications across different industries. By effectively utilizing the pellets derived from the preceding stages of production, the injection molding module 402 plays a crucial role in turning raw materials into high-quality composite products ready for market use. The pellets may be molded into a variety of finished products, including but not limited to logistics pallets, hangers, construction materials, automotive components, and eco-friendly consumer goods.

By utilizing cotton waste in this manner, the present invention not only reduces textile waste but also enhances the mechanical properties of thermoplastic composites, contributing to more sustainable and high-performance materials for a range of industrial applications.

The compacted shape and size of the blended composition or the reinforced composite material as an output from the injection molding module 402 is due to the structure of a shaping die in the injection molding module 402. The shape of the shaping die decides the output shape of the finished product. The shape of the output may be cylindrical, rectangular, square, or other known shapes.

Further, the length of the shaping die decides the length of the finished product leaving the injection molding module 402. The length of the shaping die may cause a breaking line over the output at a certain length due to gravity applying over the output.

Alternatively, the injection molding module 402 may comprise a cutting unit or a mechanical cutter for breaking the output or the compacted blended composition.

The various materials involved in the formation of the blended composition. The composition includes (a) the airborne yarn waste, (b) the bonding agent, (c) a thermoplastic polymer, and (d) the final reinforced composite material, also referred to as the blended composition throughout this specification. The blended composition is formed by incorporating airborne yarn waste, derived from the cotton waste plug, into a thermoplastic polymer matrix, including the bonding agent, creating the final reinforced composite material with enhanced bio-mechanical properties.

The cotton waste plug serves as the primary source of airborne yarn waste, which is compounded with the thermoplastic polymer through a melting compounding process. This process ensures a uniform distribution of fibers within the polymer matrix, leading to a reinforced composite material with superior tensile strength, impact resistance, and durability. Once blended, the reinforced composite material undergoes further processing, such as injection molding, compression molding, or extrusion molding, to produce finished products.

In one exemplary embodiment, the blended composition consists of 12% the airborne yarn waste and 88% thermoplastic polymer, specifically High-Density Polyethylene (HDPE) (other chemical agents). This composition has demonstrated a 22% improvement in tensile strength compared to non-reinforced thermoplastic materials. In other embodiments, the airborne yarn waste content in the blended composition ranges from 12% to 30%, while the thermoplastic polymer content ranges from 70% to 88%, allowing for flexibility in material properties depending on the intended application.

The thermoplastic polymer used in the blended composition can include one or more of polypropylene (PP), polyethylene terephthalate (PET), low-density polyethylene (LDPE), polycarbonate (PC), acrylonitrile butadiene styrene (ABS), polylactic acid (PLA), or polyamide (PA), providing versatility in a material selection based on application-specific requirements.

The bonding agent, such as Orevac or any maleic anhydride, is mixed with high-density polyethylene (HDPE) at a typical ratio of 92% HDPE and 8% bonding agent to create a compatible polymer blend, which is then combined with cotton waste plugs or collected airborne yarn waste to produce a reinforced composite material with improved mechanical properties and fiber-matrix adhesion.

Post-consumer textile waste presents greater challenges due to the presence of dyes, finishes, and blended fibers. One potential solution involves cryogenic milling, where worn or discarded cotton garments are frozen and pulverized into a fine powder. This powder, although no longer suitable for textile applications, can be compounded with high-density polyethylene (HDPE) to create reinforced composites. This post-consumer approach not only diverts complex waste from landfills but also adds mechanical strength to the HDPE matrix, offering a second life to discarded textiles in durable, non-textile applications.

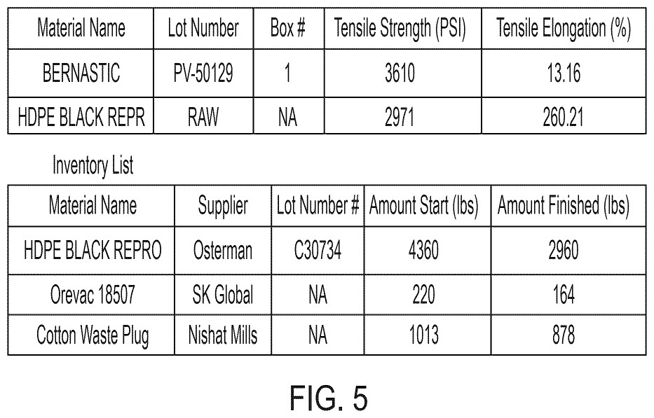

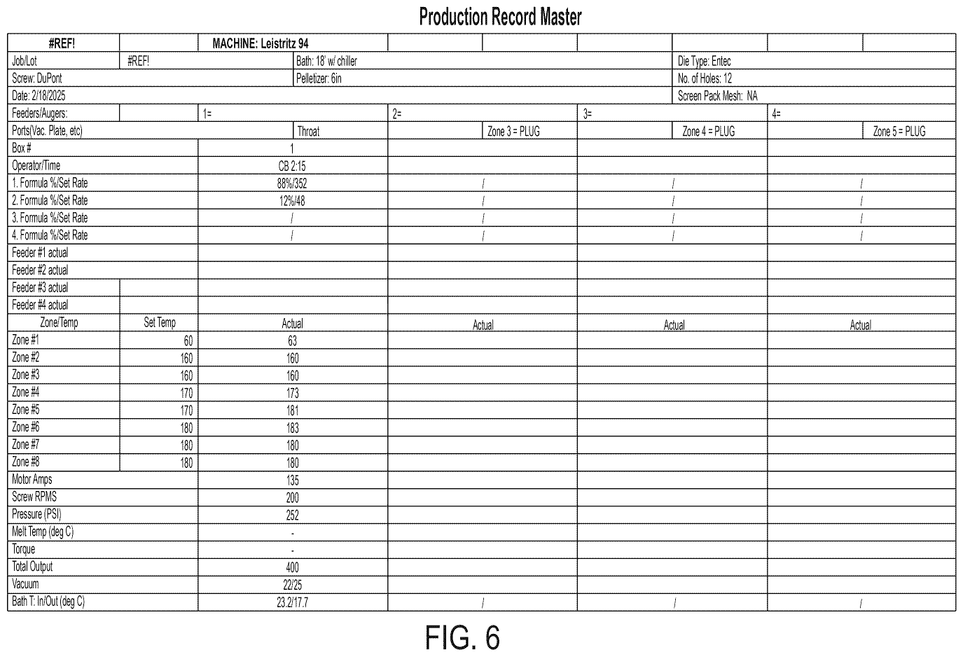

FIGS. 5 and 6 illustrate test results of the final reinforced composite after pelletizing and before injection molding in accordance with an embodiment of the present invention. In the present invention, the reinforced composite material (BERNASTIC) is manufactured by collecting airborne yarn waste and, or cotton waste dust to be compounded with a thermoplastic polymer and bonding agent. The thermoplastic polymers are High-Density Polyethylene, Black, and Reprocessed (HDPE BLACK REPRO). The bonding agent (maleic annhydride) is Orevac 18507. The amount of cotton waste plugs, HDPE BLACK REPRO, and Orevac being mixed is 1013, 4360, and 220, respectively. As a result, the tensile strength of the reinforced composite material is 3610 PSI (22% improvement) and tensile elongation improvement is 13.16%.

To further enhance the mechanical properties and functional performance of HDPE composites, reinforcement can extend beyond cotton waste powder to include rigid, mineral-based fillers such as crushed porcelain, quartz, and feldspar. These ceramic and silicate materials introduce significant hardness, abrasion resistance, and dimensional stability to the composite, complementing the fibrous reinforcement provided by the cotton waste. Crushed porcelain and quartz, with their high compressive strength and thermal resistance, improve stiffness and impact resistance, while feldspar contributes to the composite's toughness and thermal stability

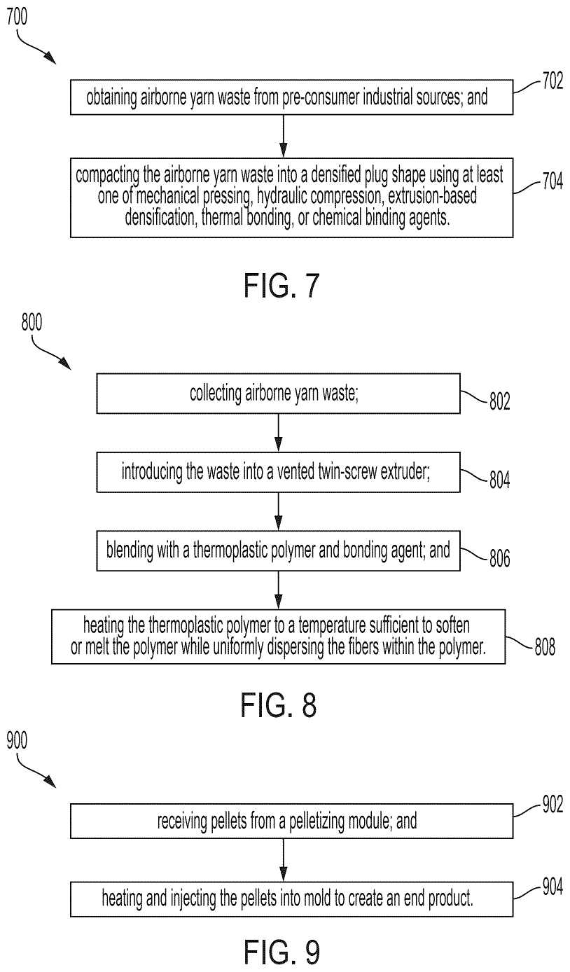

FIG. 7 illustrates a method 700 flow diagram for manufacturing a cotton waste plug in accordance with an embodiment of the present invention. The method 700 comprises the steps of a) obtaining airborne yarn waste from pre-consumer industrial sources 702; and b) compacting the airborne yarn waste into a densified plug shape using at least one of mechanical pressing, hydraulic compression, extrusion-based densification, thermal bonding, or chemical binding agents 704.

The collection of airborne yarn waste is essential for reducing environmental impact by reusing materials that would otherwise be discarded.

This compaction process results in the densified plug shape that is not only compact but also durable, making it suitable for efficient storage and transportation. The enhanced density of the plug reduces storage space requirements and facilitates handling, contributing to cost savings and environmental benefits.

FIG. 8 illustrates a method 800 flow diagram for forming a blended composition in accordance with an embodiment of the present invention. The method 800 comprises the steps of: a) collecting airborne yarn waste 802; b) introducing the waste into a vented twin-screw extruder 804; c) blending with a thermoplastic polymer and bonding agent 806; and d) heating the thermoplastic polymer to a temperature sufficient to soften or melt the polymer while uniformly dispersing the fibers within the polymer 808.

Further, extruding the blended composition into a continuous form or pelletizing the material using a strand-cut die system. In other embodiments, a spooling version of the extruded strands may be possible that will allow it to work with 3D printers. The strands emerging from the die may be introduced into a water bath to solidify while retaining residual heat to evaporate surface moisture before cutting into pellets and ensuring the pelletized material is dried before injection molding, using a customer-equipped dryer system to remove any moisture absorbed from the atmosphere during storage or transport. Further, the dried, pelletized material is injection molded into an end product, and the end product is a structural product used for transport and storage applications.

The reinforced composite material involves using a specific thermoplastic polymer, such as polypropylene or polyethylene, which is heated to a suitable temperature to ensure optimal softening and melting while uniformly dispersing the cotton waste fibers or the airborne yarn waste fibers within the polymer matrix. This enhances the mechanical properties of the composite by ensuring compatibility between the polymer and the fibers.

Further, the method focuses on improving the dispersion of cotton waste fibers or airborne yarn waste fibers within the thermoplastic polymer matrix. This is achieved by incorporating a mixing aid during the blending process. The low-shear screw design of the extruder is further optimized to minimize fiber breakage, ensuring a uniform distribution of fibers throughout the composite material.

The extrusion process is customized to produce a continuous form with specific dimensions, such as cylindrical rolls, which can be directly used in various applications without the need for pelletizing. This approach reduces processing steps and enhances the efficiency of the manufacturing process.

The method may use advanced drying techniques during the pelletizing process. Instead of a water bath, a controlled air drying system is employed to solidify the strands while minimizing moisture absorption. This ensures that the pellets have a lower moisture content, which is crucial for maintaining the quality and consistency of the composite material during injection molding.

The strands may enter a conveyor belt that is enclosed and air conditioned in order to solidify the strands while minimizing moisture absorption.

The injection molding process specializes in producing complex geometries or thin-walled parts. This is achieved by using high-pressure injection molding machines and optimizing the mold design to ensure uniform filling and cooling of the composite material. The result is a finished product with enhanced structural integrity and aesthetic appeal.

The present invention involves combining cotton waste plugs with other reinforcement materials, such as carbon fibers or glass fibers, to produce the reinforced composite material. This approach allows for tailoring the mechanical properties of the composite material to meet specific application requirements, such as improved strength, stiffness, or impact resistance. The reinforcement is achieved during the blending process, ensuring a uniform distribution of all reinforcement materials within the thermoplastic polymer matrix.

While not illustrated, in one embodiment, the blending process for incorporating the cotton waste plug into the thermoplastic polymer, such as HDPE, is designed to accommodate a higher cotton waste content, increasing from 12% to up to 30%. This process involves the low-shear screw design within the compounding extruder to minimize heat buildup and prevent thermal degradation or “burning” of the cotton fibers. Due to the low bulk density of cotton waste, a side-feeding system is utilized to ensure consistent material input. An Acrison feeder, equipped with dual agitators in the hopper, may be implemented to improve feeding efficiency and maintain a steady material flow. Additionally, the de-lumper (lump breaker) may be used to break down larger fiber clusters, promoting better dispersion during compounding.

A vented compounding extruder, such as a Farrel Continuous Mixer or a parallel twin-screw extruder (e.g., Leistritz, Coperion), may be employed to facilitate fiber dispersion while utilizing vacuum venting to remove residual moisture. The pelletizing process is performed using a strand-cut die system, which allows the extruded strands to briefly contact water or A.C.-enclosed conveyor belt before being cut into pellets, leveraging residual heat to promote surface water evaporation. To further control moisture absorption, downstream processing may include a drying system to remove any atmospheric moisture from the pellets before injection molding or extrusion.

Increasing the airborne yarn waste content in the composite material by up to 30% offers potential benefits, including reducing dependency on virgin (or recycled) HDPE, lowering production costs, and improving the sustainability of the final product. The increased fiber content may also enhance mechanical properties, such as tensile strength, impact resistance, and thermal and acoustic insulation, making the composite material suitable for a range of applications, including logistics pallets, hangers, construction materials, automotive components, and eco-friendly consumer goods.

FIG. 9 illustrates a method 900 flow diagram for injection molding a blended composition to form an end product in accordance with an embodiment of the present invention. The method comprises the steps of a) receiving pellets from a pelletizing module 902 and; b) heating and injecting the pellets into mold to create an end product 904.

In step 902, the blended composition is processed into pellet form for ease of handling and uniformity in material properties.

In step 904, the molten material is subsequently injected into a mold under controlled pressure and temperature conditions. Inside the mold, the material takes the shape of the cavity, forming the desired configuration of the end product. The molded product is then allowed to cool and solidify within the mold, ensuring dimensional stability and structural integrity. Finally, the solidified product is ejected from the mold, completing the process. This method 900 ensures efficient transformation of blended compositions into high-quality finished products with precise shapes and properties suitable for various industrial applications.

Since various possible embodiments might be made of the above invention, and since various changes might be made in the embodiments above set forth, it is to be understood that all matter herein described or shown in the accompanying drawings is to be interpreted as illustrative and not to be considered in a limiting sense. Thus, it will be understood by those skilled in the art that although the preferred and alternate embodiments have been shown and described in accordance with the Patent Statutes, the invention is not limited thereto or thereby.

The terminology used herein is for the purpose of describing particular embodiments only and is not intended to be limiting to the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present invention and some of its advantages have been described in detail for some embodiments. It should also be understood that various changes, substitutions, and alterations can be made herein without departing from the spirit and scope of the invention as defined by the appended claims. An embodiment of the invention may achieve multiple objectives, but not every embodiment falling within the scope of the attached claims will achieve every objective.

1. A blended composition, the composition comprising:
airborne yarn waste and/or cotton waste dust (waste/dust) in a plug form;
a bonding agent; and
a thermoplastic polymer, wherein the waste/dust is compounded with the thermoplastic polymer and the bonding agent to form a reinforced composite material.

2. The composition of claim 1, wherein the waste/dust is from at least one of cotton, wool, flax, hemp, jute, polyester, nylon, or other natural or synthetic textile fibers obtained from post-consumer or post-industrial apparel waste.

3. The composition of claim 1, wherein the waste/dust is processed into a plug form by collecting the waste/dust; densifying the fibers; and compacting the fibers into a cylindrical plug shape.

4. The composition of claim 3, wherein the fiber is compacted into plug form using at least one of mechanical pressing, hydraulic compression, extrusion-based densification, thermal bonding, or chemical binding agents to form a plug structure.

5. The composition of claim 1, wherein the thermoplastic polymer comprises high-density polyethylene (HDPE).

6. The composition of claim 1, wherein the thermoplastic polymer comprises at least one of polypropylene (PP), polyethylene terephthalate (PET), low-density polyethylene (LDPE), polycarbonate (PC), acrylonitrile butadiene styrene (ABS), polylactic acid (PLA), or polyamide (PA).

7. The composition of claim 3, wherein the plugs are blended with the thermoplastic polymer in a melt compounding process using at least one of a twin-screw extruder, continuous mixer, or batch mixer, wherein the compressed plugs are introduced into the system at a controlled rate to ensure uniform fiber dispersion.

8. The composition of claim 7, wherein the blending process includes side feeding the compressed plugs into the polymer melt through a controlled feeder system.

9. The composition of claim 7, wherein the blended composition is pelletized through an extrusion process to form pellets for subsequent molding or forming operations.

10. The composition of claim 7, wherein the blended composition is extruded into a continuous string form for 3-D printing into a product form.

11. The composition of claim 7, wherein the finished product comprises a pallet formed by at least one of injection molding, compression molding, or extrusion molding.

12. A cotton waste plug comprising:
airborne yarn waste and/or cotton waste dust (waste/dust); and
a densified structure formed by compressing the waste/dust into a plug-like shape.

13. The cotton waste plug of claim 12, wherein the waste/dust comprises at least one of cotton, wool, flax, hemp, jute, polyester, nylon, or other natural or synthetic textile fibers.

14. The cotton waste plug of claim 12, wherein the compression process yields a non-cylindrical form.

15. The cotton waste plug of claim 12, wherein the compression process is performed using at least one of mechanical pressing, hydraulic compression, extrusion-based densification, thermal bonding, or chemical binding agents.

16. A method of forming a blended composition, comprising:
collecting airborne yarn waste and/or cotton waste dust (waste/dust);
introducing the waste/dust into a vented twin-screw extruder;
blending with a thermoplastic polymer and bonding agent; and
heating the thermoplastic polymer to a temperature sufficient to soften or melt the polymer while uniformly dispersing the fibers within the polymer.

17. The method of claim 16, wherein the thermoplastic polymer comprises at least one of high-density polyethylene (HDPE), polypropylene (PP), polyethylene terephthalate (PET), or another thermoplastic polymer compatible with fiber reinforcement.

18. The method of claim 16, further comprises pelletizing the blended composition using a strand-cut die system, wherein the strands emerging from the die are introduced into a water bath to solidify while retaining residual heat to evaporate surface moisture before cutting into pellets.

19. The method of claim 18, further comprises ensuring that the pelletized material is dried before injection molding, using a customer-equipped dryer system to remove any moisture absorbed from the atmosphere during storage or transport.

20. The method of claim 19, wherein the dried, pelletized material is injection molded into an end product, wherein the end product is a structural product used for transport and storage applications.

21. The method of claim 16, further comprising the step of extruding as a string form for spooling configured for 3-D printing products.

22. An apparatus for manufacturing a cotton waste plug comprising:
an input source unit to receive and vacuum airborne yarn waste and/or cotton waste dust (waste/dust) from the air through a negative air environment;
a plunger unit for compacting the received waste/dust;
an output unit for outputting the compacted waste/dust into a densified plug shape.

23. The apparatus of claim 22, wherein the plunger unit compacts the waste/dust into the densified plug shape using at least one of mechanical pressing, hydraulic compression, extrusion-based densification, thermal bonding, or chemical binding agents.

24. The apparatus of claim 22, wherein the output unit includes a shaping die structure to output the compacted cylindrical shape cotton waste plug.
